(19) United States
(12) Patent Application Publication
(10) Pub. No.: US 2026/0042151 A1
(43) Pub. Date: Feb. 12, 2026

(54) TOOLS AND CUTTING DEVICES THAT INCLUDES RHENIUM

(71) Applicant: MiRus LLC, Marietta, GA (US)

(72) Inventor: Noah Roth, Marietta, GA (US)

(21) Appl. No.: 19/290,853

(22) Filed: Aug. 5, 2025

Related U.S. Application Data
(60) Provisional application No. 63/680,747, filed on Aug. 8, 2024.

(51) Int. Cl. B23B 27/14; B22F 10/64; B33Y 10/00; B33Y 40/20; B33Y 80/00; C22C 1/04; C22C 14/00; C22C 19/07; C22C 27/02; C22C 27/06; C22C 30/00; C22C 33/02; C22C 38/00; C22C 38/02; C22C 38/04; C22C 38/06; C22C 38/08; C22C 38/10; C22C 38/12; C22C 38/14; C22C 38/16; C22C 38/18; C22C 38/60

(52) U.S. Cl. CPC B23B 27/148; B22F 10/64; B33Y 10/00; B33Y 40/20; B33Y 80/00; C22C 1/0433; C22C 1/045; C22C 1/0458; C22C 14/00; C22C 19/07; C22C 27/02; C22C 27/06; C22C 30/00; C22C 33/02; C22C 38/002; C22C 38/02; C22C 38/04; C22C 38/06; C22C 38/08; C22C 38/10; C22C 38/12; C22C 38/14; C22C 38/16; C22C 38/18; C22C 38/60; B22F 2301/15; B22F 2301/20; B22F 2301/205; B22F 2301/35; B22F 2998/10; B22F 2999/00

(57) ABSTRACT

A machine tool, a machine component, a cutting blade, a drill bit, a grinding device, or a shredding/crushing device that is at least partially formed of a metal alloy that includes rhenium; said metal alloy includes a) at least 5 awt. % rhenium or b) at least 5 wt. % rhenium.

### REFERENCED APPLICATION

The present disclosure claims priority on U.S. Provisional Application Ser. No. 63/680,747 filed Aug. 8, 2024, which is incorporated herein by reference.

### TECHNICAL FIELD

The present disclosure relates generally to tools and cutting devices that are partially of fully formed of a material that includes rhenium, and more particularly to machine tools, machine components, cutting blades, drill bits, grinding bits, shredding/crushing devices, and the like that are partially of fully formed of a material that includes rhenium.

### BACKGROUND OF DISCLOSURE

For many cutting applications, improved hardness of the cutting tool is generally desirable so as to reduce the rate to which the cutting surface wears away or becomes dull. For machine tools, it is generally desirable to have the machine tool formed of a high hardness material, yet have a degree of ductility to limit the breakage of the machine tool during use.

### SUMMARY OF DISCLOSURE

The present disclosure is directed to machine tools, machine components, cutting blades, drill bits, grinding bits, shredding/crushing devices and the like that are partially of fully formed of a material that includes rhenium. The use of rhenium has been found to include both the hardness and ductility of the material that is used to partially or fully form the machine tools, cutting blades, drill bits, grinding bits and the like. The amount of rhenium that is included in the material that is used to partially or fully form the machine tools, cutting blades, drill bits, grinding bits, shredding/crushing devices and the like is at least 5 awt. % (atomic percent) (e.g., 5-90 awt. % and all values and ranges therebetween). As used herein, atomic weight percent (awt. %) or atomic percentage (awt. %) or atomic percent (awt. %) are used interchangeably. The abbreviations at. % and awt. % are used interchangeably. As defined herein, the weight percentage (wt. %) of an element is the weight of that element measured in the sample divided by the weight of all elements in the sample multiplied by 100. The atomic percentage, atomic percent or atomic weight percent (awt. % or at. %) is the number of atoms of that element, at that weight percentage, divided by the total number of atoms in the sample multiplied by 100. The use of the terms weight percentage (wt. %) and atomic percentage or atomic weight percentage or atomic percent (awt. % or at. %) are two ways of referring to metallic alloy and its constituents. In another non-limiting embodiment, the amount of rhenium that is included in the material that is used to partially or fully form the machine tools, cutting blades, drill bits, grinding bits, shredding/crushing devices and the like is at least 15 awt. % (atomic percent). In another non-limiting embodiment, the amount of rhenium that is included in the material that is used to partially or fully form the machine tools, cutting blades, drill bits, grinding bits, shredding/crushing devices and the like is at least 5 wt. % (weight percent) (e.g., 5-90 wt. % and all values and ranges therebetween).

In one non-limiting aspect of the present disclosure, there is provided a cutting blade wherein at least the cutting edge of the cutting blade is formed of or coated with a metal alloy that includes at least 5 awt. % rhenium or at least 5 wt. % rhenium. As can be appreciated, the region of the cutting blade other than the cutting edge can also be formed of or coated with a metal alloy that includes at least 5 awt. % rhenium or at least 5 wt. % rhenium. When the cutting edge of the cutting blade is coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the cutting blade is non-limiting. The cutting blade can a) be used in mining, b) be used on machines form cutting tunnels or other underground passageway, c) be used to cut or clean pipe cavities, d) be used to cut wood, metal, ceramic, concrete, tiles, glass, gems, composite materials, etc., or to cut other items and/or materials.

In accordance with another and/or alternative aspect of the present disclosure, there is provided a hammer mill hammer wherein at least the impact region of the hammer mill hammer is formed of a metal alloy that includes at least 5 awt. % rhenium or at least 5 wt. % rhenium. As can be appreciated, the region of the hammer mill hammer other than the impact region can also be formed of a metal alloy that includes at least 5 awt. % rhenium or at least 5 wt. % rhenium. In one non-limiting embodiment, 80-100% (and all values and ranges therebetween) of the hammer mill hammer is formed of the metal alloy that includes at least 5 awt. % rhenium or at least 5 wt. % rhenium. In another non-limiting embodiment, 10-100% (and all values and ranges therebetween) of the hammer mill hammer is coated with the metal alloy that includes at least 5 awt. % rhenium or at least 5 wt. % rhenium. In another non-limiting embodiment, one or more cavities are formed in the body of the hammer mill hammer and such cavities are filled with the metal alloy that includes at least 5 awt. % rhenium or at least 5 wt. % rhenium. When the hammer mill hammer is partially or fully coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). When the hammer mill hammer includes one or more cavities that includes the metal alloy that includes at least 5 awt. % rhenium or at least 5 wt. % rhenium, such metal alloy can be inserted into the cavity by a) inserting molten metal alloy into the cavity, b) inserting a preformed insert of such metal alloy in the one or more cavities, or c) inserting such metal alloy into the cavity by electroplating, galvanizing, powder coating, anodizing, Physical Vapor Deposition (PVD), Chemical Vapor Deposition (CVD), plasma spraying, and/or a metal powder and sintering. The shape and size of the hammer mill hammer blade are non-limiting. The use of the material that includes rhenium results in improved abrasion resistance and improved impact resistance, thereby improving the wear resistance and extending the useful life of the hammer mill hammer as compared to conventional hammer mill hammers.

In accordance with another and/or alternative aspect of the present disclosure, there is provided a drill bit wherein at least the cutting edge or cutting region of the drill bit is formed of or coated with a metal alloy that includes at least 5 awt. % rhenium or at least 5 wt. % rhenium. As can be appreciated, the region of the drill bit other than the cutting edge or cutting region can also be formed of or coated with a metal alloy that includes at least 5 awt. % rhenium or at least 5 wt. % rhenium. When the cutting edge of the drill bit is coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the drill bit are non-limiting. The drill bit can be used in mining, to cut or drill holes in various materials (e.g., wood, metal, ceramic, concrete, tiles, glass, composite materials, gems, etc.). The use of the material that includes rhenium results in improved abrasion resistance, thereby improving the wear resistance and extending the useful life of the drill bit as compared to conventional drill bits.

In accordance with another and/or alternative aspect of the present disclosure, there is provided a grinding bit or grinding wheel wherein at least the grinding edge of the grinding bit or grinding wheel is formed of or coated with a metal alloy that includes at least 5 awt. % rhenium or at least 5 wt. % rhenium. As can be appreciated, the region of the grinding bit or grinding wheel other than the grinding edge can also be formed of or coated with a metal alloy that includes at least 5 awt. % rhenium or at least 5 wt. % rhenium. When the grinding edge of the grinding bit or grinding wheel is coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the grinding bit or grinding wheel are non-limiting. As can be appreciated, filing devices can be considered a type of grinder. The use of the material that includes rhenium results in improved abrasion resistance, thereby improving the wear resistance and extending the useful life of the grinding device as compared to conventional grinding devices.

In accordance with another and/or alternative aspect of the present disclosure, there is provided a shredding device wherein at least the portion of the shredding device used to contact materials to be shredded is formed of or coated with a metal alloy that includes at least 5 awt. % rhenium or at least 5 wt. % rhenium. As can be appreciated, the region of the shredding device other than the shedding portion can also be formed of or coated with a metal alloy that includes at least 5 awt. % rhenium or at least 5 wt. % rhenium. When the portion of the shredding device used to contact materials to be shredded is coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the shredding device are non-limiting. The use of the material that includes rhenium results in improved abrasion resistance and improved impact resistance, thereby improving the wear resistance and extending the useful life of the shredding device as compared to conventional shredding devices.

In accordance with another and/or alternative aspect of the present disclosure, there is provided a crushing device wherein at least the portion that contacts materials to be crushed is formed of or coated with a metal alloy that includes at least 5 awt. % rhenium or at least 5 wt. % rhenium. As can be appreciated, the region of the crushing device other than the crushing region can also be formed of or coated with a metal alloy that includes at least 5 awt. % rhenium or at least 5 wt. % rhenium. When the portion of the crushing device that contacts materials to be crushed is coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the crushing device are non-limiting. The use of the material that includes rhenium results in improved abrasion resistance and improved impact resistance, thereby improving the wear resistance and extending the useful life of the crushing device as compared to conventional crushing device.

In accordance with another and/or alternative aspect of the present disclosure, there is provided machine tools (e.g., wrenches, plies, screw drives, hammers, crow bar, etc.) that require an improved hardness for durability and/or an improved ductility to reduce breakage wherein at least the portion or all of the machine tool is formed of or coated with a metal alloy that includes at least 5 awt. % rhenium or at least 5 wt. % rhenium. When the machine tools are partially or fully coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the machine tool are non-limiting. The use of the material that includes rhenium results in improved resistance to damage and improved ductility, thereby extending the useful life of the machine tools as compared to conventional machine tools.

In accordance with another and/or alternative aspect of the present disclosure, there is provided machine components (e.g., axles, gears, clutch components, etc.) that require an improved hardness for durability and/or an improved ductility to reduce breakage wherein at least the portion or all of the machine components is formed of or coated with a metal alloy that includes at least 5 awt. % rhenium or at least 5 wt. % rhenium. When the machine components are partially or fully coated with the metal alloy that includes at least 5 awt. % rhenium or at least 5 wt. % rhenium, the coating thickness of the metal alloy coating is at least 1 microns (e.g., 1-2000 microns and all values and ranges therebetween). The coating process is non-limiting (e.g., electroplating, galvanizing, powder coating, anodizing, Physical Vapor Deposition (PVD), Chemical Vapor Deposition (CVD), plasma spraying, metal powder and sintering, etc.). The shape and size of the machine components are non-limiting. The use of the material that includes rhenium results in improved abrasion resistance and improved impact resistance, thereby improving the wear resistance and ductility and extending the useful life of the machine components as compared to conventional machine components.

In accordance with another and/or alternative aspect of the present disclosure, the metal alloy that is used to partially or fully formed the machine tools, machine components, cutting blades, drill bits, grinding bits, shredding/crushing devices and the like includes at least 15 awt. % rhenium, and at least 0.1 wt. % (e.g., 0.1 wt. % to 96 wt. % and all values and ranges therebetween) of one or more metals, and/or one or more carbides or diborides (e.g., rhenium diboride (ReB₂), tungsten carbide, silicon carbide, titanium diboride, zirconium diboride, boron carbide, etc.). As defined herein, the metal alloy includes metal/ceramic hybrid materials or cermet materials (e.g., metal carbides, metal diborides, etc.). The rhenium content of the metal alloy can be in the form of rhenium particles, rhenium alloy, rhenium alloy particles, rhenium carbide, and/or rhenium biboride. In one non-limiting embodiment, the metal alloy is absent carbide and/or boride materials. In another non-limiting embodiment, the metal alloy includes one or both of carbide and/or boride materials. When the metal alloy includes one or both of carbide and/or boride materials, the metal alloy is partially of fully formed by a sintering process. In one non-limiting arrangement, the sinter process can occur at 1200-1800° C. (and all values and ranges therebetween) for 5-400 minutes (and all values and ranges therebetween). The sinter process can optionally occur in a protective atmosphere. The sintering process can occur in a vacuum or with high pressure (e.g., hot isostatic pressing). During the sintering process, one or more binder metals or metal alloys are generally used (e.g., cobalt, nickel, rhenium, molybdenum, chromium, niobium, tantalum, vanadium, titanium, osmium, hafnium, iridium, rhodium, ruthenium, etc. and any metal alloy thereof that contains one or more of such metals).

In accordance with another and/or alternative aspect of the present disclosure, the metal alloy that is used to partially or fully formed the machine tools, machine components, cutting blades, drill bits, grinding bits, shredding/crushing devices and the like includes at least 5 awt. % (e.g., 5-99 awt. % and all values and ranges therebetween) rhenium, and at least 0.1 wt. % (e.g., 0.1 wt. % to 96 wt. % and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium, one or more carbides or diborides of such metals (e.g., rhenium diboride (ReB₂), tungsten carbide, silicon carbide, titanium diboride, zirconium diboride, boron carbide, etc.), and the metal alloy optionally includes 0-2 wt. % (and all values and ranges therebetween) of a combination of other metals, oxygen, phosphorous, sulfur, hydrogen and/or nitrogen.

In accordance with another and/or alternative aspect of the present disclosure, the metal alloy that is used to partially or fully formed the machine tools, machine components, cutting blades, drill bits, grinding bits, shredding/crushing devices and the like includes one or more carbides or diborides (e.g., rhenium diboride (ReB₂), tungsten carbide, silicon carbide, titanium diboride, zirconium diboride, boron carbide, etc.), and a binder material that a) is rhenium, b) is a rhenium alloy, or c) includes rhenium and/or rhenium alloy and one or more other metals or metal alloys, and which such one or more other metals or metal alloys are fully formed of or include one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium. In one non-limiting arrangement, the metal alloy includes one or more carbides or diborides (e.g., rhenium diboride (ReB₂), tungsten carbide, silicon carbide, titanium diboride, zirconium diboride, boron carbide, etc.), and a binder material is s sintered metal alloy. The another non-limiting arrangement, the rhenium content of the metal alloy is at least 5 awt. % (e.g., 5-90 awt. % and all values and ranges therebetween), and at least 0.1 wt. % (e.g., 0.1 wt. % to 95 wt. % and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium, one or more carbides or diborides of such metals (e.g., rhenium diboride (ReB₂), tungsten carbide, silicon carbide, titanium diboride, zirconium diboride, boron carbide, etc.), and the metal alloy optionally includes 0-2 wt. % (and all values and ranges therebetween) of a combination of other metals, oxygen, phosphorous, sulfur, hydrogen and/or nitrogen.

In accordance with another and/or alternative aspect of the present disclosure, the metal alloy that is used to partially or fully formed the machine tools, machine components, cutting blades, drill bits, grinding bits, shredding/crushing devices and the like includes rhenium and molybdenum, and the weight percent of rhenium in the metal alloy is greater that the weight percent of molybdenum in the metal alloy. In one non-limiting embodiment, the metal alloy includes rhenium and molybdenum, and the weight percent of rhenium in the metal alloy is greater that the weight percent of molybdenum in the metal alloy, and the weight percent of rhenium is greater than the combined weight percent of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium. In another non-limiting arrangement, the combined weight percent of aluminum, boron, beryllium, bismuth, cadmium, calcium, carbon, cerium, chromium, cobalt, copper, gallium, gold, hafnium, iridium, iron, lanthanum, lithium, magnesium, manganese, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium is greater than the weight percent of molybdenum in the metal alloy, In another non-limiting arrangement, and the metal alloy optionally includes 0-2 wt. % (and all values and ranges therebetween) of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium. In another non-limiting arrangement, the metal alloy includes one or more carbides or diborides (e.g., rhenium diboride (ReB₂), tungsten carbide, silicon carbide, titanium diboride, zirconium diboride, boron carbide, etc.).

In accordance with another and/or alternative aspect of the present disclosure, the metal alloy that is used to partially or fully formed the machine tools, machine components, cutting blades, drill bits, grinding bits, shredding/crushing devices and the like includes a) rhenium, b) one or more of molybdenum, bismuth, niobium, tantalum, tungsten, titanium, vanadium, chromium, manganese, yttrium, zirconium, technetium, ruthenium, rhodium, hafnium, osmium, copper, and iridium, and c) optionally one or more carbides or diborides (e.g., rhenium diboride (ReB₂), tungsten carbide, silicon carbide, titanium diboride, zirconium diboride, boron carbide, etc.), and the metal alloy optionally includes 0-2 wt. % (and all values and ranges therebetween) of a combination of oxygen, phosphorous, sulfur, hydrogen, nitrogen, and metals other than rhenium, molybdenum, bismuth, niobium, tantalum, tungsten, titanium, vanadium, chromium, manganese, yttrium, zirconium, technetium, ruthenium, rhodium, hafnium, osmium, copper, and iridium.

In accordance with another and/or alternative aspect of the present disclosure, the metal alloy that is used to partially or fully formed the machine tools, machine components, cutting blades, drill bits, grinding bits, shredding/crushing devices and the like includes a) at least 5 awt. % (e.g., 5-90 awt. % and all values and ranges therebetween) rhenium, b) at least two metals selected from the group of molybdenum, bismuth, chromium, iridium, niobium, tantalum, titanium, yttrium, and zirconium, and c) and c) optionally one or more carbides or diborides (e.g., rhenium diboride (ReB₂), tungsten carbide, silicon carbide, titanium diboride, zirconium diboride, boron carbide, etc.), and the metal alloy optionally includes 0-2 wt. % (and all values and ranges therebetween) of a combination of oxygen, phosphorous, sulfur, hydrogen, nitrogen, and metals other than rhenium, molybdenum, bismuth, chromium, iridium, niobium, tantalum, titanium, yttrium, and zirconium. In another non-limiting embodiment, the metal alloy includes rhenium, molybdenum and/or chromium, and optionally one or more carbides or diborides (e.g., rhenium diboride (ReB₂), tungsten carbide, silicon carbide, titanium diboride, zirconium diboride, boron carbide, etc.). In another non-limiting embodiment, the metal alloy includes a) at least 35 wt. % (e.g., 35-75 wt. % and all values and ranges therebetween) rhenium, b) at least 25 wt. % (e.g., 25-49.9 wt. % and all values and ranges therebetween) chromium, c) 0.1-40 wt. % (and all values and ranges therebetween) of one or more of aluminum, boron, beryllium, bismuth, cadmium, calcium, carbon, cerium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % chromium (and all values and ranges therebetween), c) 0.1-40 wt. % (and all values and ranges therebetween) of one or more of aluminum, boron, beryllium, bismuth, cadmium, calcium, carbon, cerium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % tantalum (and all values and ranges therebetween), c) 0.1-40 wt. % (and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, technetium, tin, titanium, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % niobium (and all values and ranges therebetween), c) 0.1-40 wt. % (and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, osmium, palladium, platinum, rare earth metals, rhodium, ruthenium, scandium, silver, silicon, tantalum, technetium, tin, titanium, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % titanium (and all values and ranges therebetween), c) 0.1-40 wt. % (and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % zirconium (and all values and ranges therebetween), c) 0.1-40 wt. % (and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, and zinc, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) 15-50 awt. % rhenium (and all values and ranges therebetween), b) 0.5-70 awt. % molybdenum (and all values and ranges therebetween), c) 0.1-40 wt. % (and all values and ranges therebetween) of one or more of aluminum, boron, beryllium, bismuth, cadmium, calcium, carbon, cerium, chromium, cobalt, copper, gallium, gold, hafnium, iridium, iron, lanthanum, lithium, magnesium, manganese, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium, and d) optionally one or more carbides or diborides (e.g., rhenium diboride (ReB₂), tungsten carbide, silicon carbide, titanium diboride, zirconium diboride, boron carbide, etc.), and optionally 0-2 wt. % of a combination of oxygen, phosphorous, sulfur, hydrogen, nitrogen, and metals other than rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

In accordance with another and/or alternative aspect of the present disclosure, the metal alloy that is used to partially or fully formed the machine tools, machine components, cutting blades, drill bits, grinding bits, shredding/crushing devices and the like includes a) at least 15 awt. % rhenium, b) greater than 50 wt. % titanium (e.g., 51-80 wt. % and all values and ranges therebetween), c) 15-45 wt. % (and all values and ranges therebetween) niobium, d) 0-10 wt. % (and all values and ranges therebetween) zirconium, e) 0-15 wt. % (and all values and ranges therebetween) tantalum, f) and 0-8 wt. % molybdenum (and all values and ranges therebetween), g) optionally one or more carbides or diborides (e.g., rhenium diboride (ReB₂), tungsten carbide, silicon carbide, titanium diboride, zirconium diboride, boron carbide, etc.).

In accordance with another and/or alternative aspect of the present disclosure, the metal alloy that is used to partially or fully formed the machine tools, machine components, cutting blades, drill bits, grinding bits, shredding/crushing devices and the like includes no more than 0.1 wt. % nickel, no more than 0.1 wt. % chromium, and/or no more than 0.1 wt. % cobalt.

In accordance with another and/or alternative aspect of the present disclosure, the metal alloy that is used to partially or fully formed the machine tools, machine components, cutting blades, drill bits, grinding bits, shredding/crushing devices and the like has one or more of the following properties: i) has a yield strength of at least 110 ksi (e.g., 100-275 ksi and all values and ranges therebetween), ii) has a modulus of elasticity of at least 35000 ksi, and/or iii) a Moh's hardness of greater than 6 (e.g., 6.05-9.8 and all values and ranges therebetween). In one non-limiting embodiment, the average Vickers hardness of the metal alloy is optionally at least about 150 Vickers (e.g., 150-300 Vickers and all values and ranges therebetween), and typically 160-240 Vickers; however, this is not required. In another and/or alternative non-limiting embodiment of the disclosure, the average ultimate tensile strength of the metal alloy is optionally at least about 125 ksi (e.g., 125-300 ksi and all values and ranges therebetween); however, this is not required. In another and/or alternative non-limiting embodiment of the disclosure, the average grain size of the metal alloy is optionally no greater than about 4 ASTM (e.g., 4 ASTM to 20 ASTM using ASTM E112 and all values and ranges therebetween, e.g., 0.35 micron to 90 micron, and all values and ranges therebetween). In another and/or alternative non-limiting embodiment of the disclosure, the average tensile elongation of the metal alloy is optionally at least about 25% (e.g., 25-50% average tensile elongation and all values and ranges therebetween).

In accordance with another and/or alternative aspect of the present disclosure, the metal alloy that is used to partially or fully formed the machine tools, machine components, cutting blades, drill bits, grinding bits, shredding/crushing devices and the like includes a certain amount of carbon and oxygen; however, this is not required. These two elements have been found to affect the forming properties and brittleness of the metal alloy. The controlled atomic ratio of carbon and oxygen of the metal alloy also minimize the tendency of the metal alloy to form micro-cracks during the forming of the metal alloy at least partially into a desired part and/or during use of the desired part. The control of the atomic ratio of carbon to oxygen in the metal alloy allows for the redistribution of oxygen in the metal alloy to minimize the tendency of micro-cracking in the metal alloy during the forming of the metal alloy, and/or during the use of the component that is formed of or includes the metal alloy. The atomic ratio of carbon to oxygen in the metal alloy is believed to facilitate in minimizing the tendency of micro-cracking in the metal alloy and improve the degree of elongation of the metal alloy, both of which can affect one or more physical properties of the metal alloy. The carbon to oxygen atomic ratio can be as low as about 0.2:1 (e.g., 0.2:1 to 50:1 and all values and ranges therebetween). In one non-limiting formulation, the carbon to oxygen atomic ratio in the metal alloy is generally at least about 0.3:1. Typically the carbon content of the metal alloy is less than about 0.1 wt. % (e.g., 0-0.0999999 wt. % and all values and ranges therebetween), and more typically 0-0.01 wt. %. Carbon contents that are too large can adversely affect the physical properties of the metal alloy. Generally, the oxygen content is to be maintained at very low level. In one non-limiting formulation, the oxygen content is less than about 0.1 wt. % of the metal alloy (e.g., 0-0.0999999 wt. % and all values and ranges therebetween), and typically 0-0.01 wt. %. In one non-limiting arrangement, the carbon to oxygen atomic ratio in the metal alloy is at least about 2.5:1 when the oxygen content is greater than about 100 ppm in the metal alloy of the metal alloy.

In accordance with another and/or alternative aspect of the present disclosure, the metal alloy that is used to partially or fully form the machine tools, machine components, cutting blades, drill bits, grinding bits, shredding/crushing devices and the like includes a controlled amount of nitrogen; however, this is not required. Large amounts of nitrogen in the metal alloy can adversely affect the ductility of the metal alloy. This can in turn adversely affect the elongation properties of the metal alloy. A too high nitrogen content in the metal alloy can begin to cause the ductility of the metal alloy to unacceptably decrease, thus adversely affect one or more physical properties of the metal alloy. In one non-limiting formulation, the metal alloy includes less than about 0.001 wt. % nitrogen (e.g., 0 wt. % to 0.0009999 wt. % and all values and ranges therebetween). It is believed that the nitrogen content should be less than the content of carbon or oxygen in the metal alloy. In one non-limiting formulation, the atomic ratio of carbon to nitrogen is at least about 1.5:1 (e.g., 1.5:1 to 400:1 and all values and ranges therebetween). In another non-limiting formulation, the atomic ratio of oxygen to nitrogen is at least about 1.2:1 (e.g., 1.2:1 to 150:1 and all value and ranges therebetween).

In accordance with another and/or alternative aspect of the present disclosure, the metal alloy that is used to partially or fully formed the machine tools, machine components, cutting blades, drill bits, grinding bits, shredding/crushing devices and the like include at least about 5 wt. % of the metal alloy (e.g., 5-100 wt. % and all values and ranges therebetween.

In accordance with another and/or alternative aspect of the present disclosure, the metal alloy that is used to partially or fully formed the machine tools, machine components, cutting blades, drill bits, grinding bits, shredding/crushing devices and the like 1) is not clad, metal sprayed, plated and/or formed (e.g., cold worked, hot worked, etc.) onto another metal, or 2) does not have another metal or metal alloy metal sprayed, plated, clad and/or formed onto the novel metal alloy. It will be appreciated that in some applications, the novel metal alloy of the present invention may be clad, metal sprayed, plated and/or formed onto another metal, or another metal or metal alloy may be plated, metal sprayed, clad and/or formed onto the novel metal alloy when forming all or a portion of the machine tools, machine components, cutting blades, drill bits, grinding bits, shredding/crushing devices and the like.

In accordance with another and/or alternative aspect of the present disclosure, the metal alloy that is used to partially or fully formed the machine tools, machine components, cutting blades, drill bits, grinding bits, shredding/crushing devices and the like is used to form a coating on a portion of all of the machine tools, machine components, cutting blades, drill bits, grinding bits, shredding/crushing devices and the like. The composition of the metal alloy coating is different from the composition of the material surface to which the metal alloy is coated. The coating thickness of the metal alloy is non-limiting (e.g., 1 μm to 1 inch and all values and ranges therebetween).

In accordance with another and/or alternative aspect of the present disclosure, the metal alloy that is used to partially or fully formed the machine tools, machine components, cutting blades, drill bits, grinding bits, shredding/crushing devices and the like can optionally be nitrided; however, this is not required. The nitriding process can be by gas nitriding, salt bath nitriding, or plasma nitriding. In gas nitriding, the nitrogen diffuses onto the surface of the metal alloy, thereby creating a nitrided layer. The thickness and phase constitution of the resulting nitriding layers can be selected and the process optimized for the particular properties required. The metal alloy can optionally be exposed to argon and/or hydrogen gas prior to the nitriding process to clean and/or preheat the metal alloy. These gases can be optionally used to clean oxide layers and/or solvents from the surface of the metal alloy. During the nitriding process, the metal alloy can optionally be exposed to hydrogen gas to inhibit or prevent the formation of oxides on the surface of the metal alloy. The thickness of the nitrided surface layer is less than about 1 mm. In one non-limiting embodiment, the thickness of the nitride surface layer is at least about 50 nanometer and less than about 1 mm (and all values and ranges therebetween). In another non-limiting embodiment, the thickness of the nitrided surface layer is at least about 50 nanometer and less than about 0.1 mm. Generally, the weight percent of nitrogen in the nitrided surface layer is 0.0001-5 wt. % nitrogen (and all values and ranges therebetween). The nitriding process for the metal alloy can be used to increase surface hardness and/or wear resistance of the machine tools, machine components, cutting blades, drill bits, grinding bits, shredding/crushing devices and the like, and/or to inhibit or prevent discoloration of the metal alloy (e.g., discoloration by oxidation, etc.).

In accordance with another and/or alternative aspect of the present disclosure, the metal alloy that is used to partially or fully formed the machine tools, machine components, cutting blades, drill bits, grinding bits, shredding/crushing devices and the like can optionally partially or fully be formed by a near net process. In one non-limiting embodiment of the disclosure, there is provided a method of powder pressing materials and optionally increasing the strength post-sintering by imparting additional cold work. In one non-limiting embodiment, the green part is pressed and then sintered. Thereafter, the sintered part is optionally again pressed to increase its mechanical strength by imparting cold work into the pressed and sintered part. Generally, the temperature during the pressing process after the sintering process is 20-100° C. (and all values and ranges therebetween), typically 20-80° C., and more typically 20-40° C. As defined herein, cold working occurs at a temperature of no more than 150° C. (e.g., 10-150° C. and all values and ranges therebetween). The change in the shape of the repressed post-sintered part needs to be determined so the final part (pressed, sintered and re-pressed) meets the dimensional requirements of the final formed part. There is also provided a process of increasing the mechanical strength of a pressed metal part by repressing the post-sintered part to add additional cold work into the material, thereby increasing its mechanical strength. There is also provided a process of powder pressing to a near net or final part using metal powder.

In accordance with another and/or alternative aspect of the present disclosure, the metal alloy that is used to partially or fully formed the machine tools, machine components, cutting blades, drill bits, grinding bits, shredding/crushing devices and the like can be formed by various techniques such as, but not limited to, 1) melting the metal alloy and/or metals that form the metal alloy (e.g., vacuum arc melting, etc.) and then extruding and/or casting the metal alloy into a portion or all of the machine tools, machine components, cutting blades, drill bits, grinding bits, shredding/crushing devices and the like, 2) consolidating the metal powder of the metal alloy and/or metal powder of metals that form the metal alloy into a portion or all of the machine tools, machine components, cutting blades, drill bits, grinding bits, shredding/crushing devices and the like, or 3) 3-D printing the metal powder of the metal alloy and/or metal powder of metals that form the metal alloy into a portion or all of the machine tools, machine components, cutting blades, drill bits, grinding bits, shredding/crushing devices and the like. In one non-limiting process, the near net medical device, near net component of a portion or all of the machine tools, machine components, cutting blades, drill bits, grinding bits, shredding/crushing devices and the like can be formed from one or more ingots of metal or metal alloy. In one non-limiting process, an arc melting process (e.g., vacuum arc melting process, etc.) can be used to form a portion or all of the machine tools, machine components, cutting blades, drill bits, grinding bits, shredding/crushing devices and the like, or near net component of a portion or all of the machine tools, machine components, cutting blades, drill bits, grinding bits, shredding/crushing devices and the like. In one non-limiting embodiment, the average particle size of the metal powders is less than about 230 mesh (e.g., less than 63 microns; 1-62 microns and all values and ranges therebetween). In another and/or alternative non-limiting embodiment, the average particle size of the metal powders is about 2-62 microns, and more particularly about 5-49.9 microns. In another and/or alternative non-limiting embodiment, the average particle size of the metal powders is about 10-40 microns. In another and/or alternative non-limiting embodiment, the average density of the metal powders is greater than 5 g/cm³ (e.g., 5.001 g/cm³ to 19.3 g/cm³ and all values and ranges therebetween). In another and/or alternative non-limiting embodiment, 10-100 vol. % (and all values and ranges therebetween) of the metal powder is spherical shaped. The purity of the metal powders should be selected so that the metal powders contain very low levels of oxygen, and nitrogen. Typically, the oxygen content is less than about 50 ppm, and the nitrogen content is less than about 20 ppm. Typically, metal powder used to form the metal alloy has a purity grade of at least 99.9 and more typically at least about 99.95.

In accordance with another and/or alternative aspect of the present disclosure, when the metal alloy that is used to partially or fully formed the machine tools, machine components, cutting blades, drill bits, grinding bits, shredding/crushing devices and the like is formed by consolidated metal powder, the metal powder is optionally pressed together to form a solid solution of the metal alloy into a near net portion or all of the machine tools, machine components, cutting blades, drill bits, grinding bits, shredding/crushing devices and the like. Typically, the pressing process is by an isostatic process (i.e., uniform pressure applied from all sides on the metal powder); however other processes can be used. When the metal powders are pressed together isostatically, cold isostatic pressing (CIP) is typically used to consolidate the metal powders; however, this is not required. The pressing process can be performed in an inert atmosphere, an oxygen-reducing atmosphere (e.g., hydrogen, argon and hydrogen mixture, etc.), and/or under a vacuum; however, this is not required. The average density of the portion or all of the near net machine tools, machine components, cutting blades, drill bits, grinding bits, shredding/crushing devices and the like that is achieved by pressing together the metal powders is about 80-95% (and all values and ranges therebetween) of the final average density of the portion or all of the near net machine tools, machine components, cutting blades, drill bits, grinding bits, shredding/crushing devices and the like, or about 70-96% (and all values and ranges therebetween) the minimum theoretical density of the metal alloy. Pressing pressures of at least about 300 MPa are generally used. Generally, the pressing pressure is about 400-700 MPa; however, other pressures can be used. After the metal powders are pressed together, the pressed metal powders are sintered to partially or fully fuse the metal powders together to form the portion or all of the near net machine tools, machine components, cutting blades, drill bits, grinding bits, shredding/crushing devices and the like. The sintering of the consolidated metal powder can be performed in an oxygen-reducing atmosphere (e.g., helium, argon, hydrogen, argon and hydrogen mixture, etc.), and/or under a vacuum; however, this is not required. At the high sintering temperatures, a high hydrogen atmosphere will reduce both the amount of carbon and oxygen in the formed portion or all of the near net machine tools, machine components, cutting blades, drill bits, grinding bits, shredding/crushing devices and the like. The sintered metal powder generally has an as-sintered average density of about 90-99% the minimum theoretical density of the metal alloy. As can be appreciated, the sintering process can be used to form a coating of metal alloy on the outer surface of a substrate (e.g., metal substrate, carbide substrate, etc.).

In accordance with another and/or alternative aspect of the present disclosure, when the metal alloy that is used to partially or fully formed the machine tools, machine components, cutting blades, drill bits, grinding bits, shredding/crushing devices and the like is formed by a 3D printing process. In one non-limiting embodiment, the average particle size of the metal powder that is used in the 3D printing process is optionally 2-62 microns, and more particularly about 5-49.9 microns, the average density of the metal powders is greater than 5 g/cm³, and the metal powder is generally spherical-shaped, and the Hall flow (s/50 g) is less than 30 seconds (e.g., 2-29.99 seconds and all values and ranges therebetween). As can be appreciated, the 3D printing process can be used to form a coating of metal alloy on the outer surface of a substrate (e.g., metal substrate, carbide substrate, etc.).

In accordance with another and/or alternative aspect of the present disclosure, an enhancement coating can optionally be allowed to a portion or all of the outer surface of the metal alloy that includes at least 5 awt. % rhenium or at least 5 wt. % rhenium. Non-limiting enhancement coatings include chromium nitride (CrN), diamond-like carbon (DLC), titanium nitride (TiN), titanium nitride oxide (TiNOx), zirconium nitride (ZrN), zirconium oxide (ZrO₂), zirconium-nitrogen-carbon (ZrNC), zirconium OxyCarbide (ZrOC), zirconium oxynitride (ZnNxOy) [e.g., cubic ZrN:O, cubic ZrO₂:N, tetragonal ZrO₂:N, and monoclinic ZrO₂:N phase coatings], and combinations of such coatings. In one non-limiting embodiment, the one or more enhancement coatings are optionally applied to the outer surface of the metal alloy by a vacuum process using an energy source to vaporize material and deposit a thin layer of enhancement coating material. Such vacuum coating process, when used, can include a physical vapor deposition (PVD) process (e.g., sputter deposition, cathodic arc deposition or electron beam heating, etc.), chemical vapor deposition (CVD) process, atomic layer deposition (ALD) process, or a plasma-enhanced chemical vapor deposition (PE-CVD) process. In one non-limiting embodiment, the coating process is one or more of a PVD, CVD, ALD and PE-CVD. In another non-limiting embodiment, the thickness of the enhancement coating is greater than 1 nanometer (e.g., 2 nanometers to 100 microns and all values and ranges therebetween). In accordance with another non-limiting embodiment, the chromium nitride (CrN) coating generally includes 40-85 wt. % Cr (and all values and ranges therebetween), 15-60 wt. % N (and all values and ranges therebetween), 0-10 wt. % Re (and all values and ranges therebetween), 0-10 wt. % Si (and all values and ranges therebetween), 0-2 wt. % O (and all values and ranges therebetween), and 0-2 wt. % C (and all values and ranges therebetween). In another non-limiting embodiment, the enhancement coating composition generally includes 65-80 wt. % Cr, 15-30 wt. % N, 0-8 wt. % Re, 0-1 wt. % Si, 0-1 wt. % O, and 0-1 wt. % C. In another non-limiting embodiment, the diamond-Like Carbon (DLC) coating generally includes 60-99.99 wt. % C (and all values and ranges therebetween), 0-2 wt. % N (and all values and ranges therebetween), 0-10 wt. % Re (and all values and ranges therebetween), 0-20 wt. % Si (and all values and ranges therebetween), and 0-2 wt. % O (and all values and ranges therebetween). In another non-limiting embodiment, all or a portion of the frame for a prosthetic heart valve are coated with the enhancement coating composition that generally includes 90-99.99 wt. % C, 0-1 wt. % N, 0-8 wt. % Re, 0-1 wt. % Si, and 0-1 wt. % O. In another non-limiting embodiment, the enhancement coating composition generally includes 20-85 wt. % Ti (and all values and ranges therebetween), 0.5-35 wt. % N (and all values and ranges therebetween), 0-10 wt. % Re (and all values and ranges therebetween), and 0.5-35 wt. % O (and all values and ranges therebetween). In another non-limiting embodiment, the enhancement coating composition generally includes 35-90 wt. % Zr (and all values and ranges therebetween), 5-25 wt. % N (and all values and ranges therebetween), 0-10 wt. % Re (and all values and ranges therebetween), 0-20 wt. % Si (and all values and ranges therebetween), 0-2 wt. % O (and all values and ranges therebetween), and 0-2 wt. % C (and all values and ranges therebetween). In another non-limiting embodiment, the enhancement coating composition generally includes 80-90 wt. % Zr, 10-20 wt. % N, 0-8 wt. % Re, 0-1 wt. % Si, 0-1 wt. % O, and 0-1 wt. % C. In another non-limiting embodiment, the enhancement coating composition generally includes 35-90 wt. % Zr (and all values and ranges therebetween), 10-35 wt. % O (and all values and ranges therebetween), 0-2 wt. % N (and all values and ranges therebetween), 0-10 wt. % Re (and all values and ranges therebetween), 0-20 wt. % Si (and all values and ranges therebetween), and 0-2 wt. % C (and all values and ranges therebetween). In another non-limiting embodiment, the enhancement coating composition generally includes 70-80 wt. % Zr, 20-30 wt. %, 0-1 wt. % N, 0-8 wt. % Re, 0-1 wt. % Si, and 0-1 wt. % C. In another non-limiting embodiment, the enhancement coating composition generally includes 40-95 wt. % Zr (and all values and ranges therebetween), 5-25 wt. % O (and all values and ranges therebetween), and 10-40 wt. % C (and all values and ranges therebetween), 0-2 wt. % N (and all values and ranges therebetween), 0-10 wt. % Re (and all values and ranges therebetween), and 0-20 wt. % Si (and all values and ranges therebetween). In another non-limiting embodiment, the enhancement coating composition generally includes 40-65 wt. % Zr, 5-25 wt. % O, and 25-40 wt. % C, 0-1 wt. % N, 0-8 wt. % Re, and 0-1 wt. % Si. In another non-limiting embodiment, the enhancement coating composition generally includes 20-85 wt. % Zr (and all values and ranges therebetween), 0.5-35 wt. % N (and all values and ranges therebetween), and 0.5-35 wt. % O (and all values and ranges therebetween). In one non-limiting embodiment, the enhancement coating composition generally includes 40-95 wt. % Zr (and all values and ranges therebetween), 5-40 wt. % N (and all values and ranges therebetween), and 5-40 wt. % C (and all values and ranges therebetween), 0-2 wt. % O (and all values and ranges therebetween), 0-10 wt. % Re (and all values and ranges therebetween), and 0-20 wt. % Si (and all values and ranges therebetween). In another non-limiting embodiment, the enhancement coating composition generally includes 40-80 wt. % Zr, 5-25 wt. % N, and 5-25 wt. % C, 0-1 wt. % O, 0-8 wt. % Re, and 0-1 wt. % Si.

One non-limiting object of the present disclosure is the provision of metal alloy in accordance with the present disclosure that includes rhenium and is used to partially or fully form machine tools, machine components, cutting blades, drill bits, grinding bits, shredding/crushing devices and the like.

Another and/or alternative non-limiting object of the present disclosure is the provision of metal alloy in accordance with the present that includes at least 5 awt. % rhenium or at least 5 wt. % rhenium and is used to partially or fully form machine tools, machine components, cutting blades, drill bits, grinding bits, shredding/crushing devices and the like.

Another and/or alternative non-limiting object of the present disclosure is the provision of metal alloy in accordance with the present disclosure that includes rhenium and is used to partially or fully form machine tools, machine components, cutting blades, drill bits, grinding bits, shredding/crushing devices and the like wherein the machine tools, machine components, cutting blades, drill bits, grinding bits, shredding/crushing devices and the like has increased strength, hardness and/or ductility.

Another and/or alternative non-limiting object of the present disclosure is the provision of a metal alloy that comprises rhenium, molybdenum, and one or more additional additives.

Another and/or alternative non-limiting object of the present disclosure is the provision of a metal alloy that comprises rhenium, molybdenum, chromium, and optionally and one or more additional additives.

Another and/or alternative non-limiting object of the present disclosure is the provision of machine tools, machine components, cutting blades, drill bits, grinding bits, shredding/crushing devices and the like that can be partially or fully formed by one or more manufacturing processes. These manufacturing processes can include, but are not limited to, laser cutting, etching, annealing, drawing, pilgering, electroplating, electro-polishing, machining, plasma coating, 3D printed coatings, 3D printing, chemical vapor deposition, chemical polishing, cleaning, pickling, ion beam deposition or implantation, sputter coating, vacuum deposition, etc. In one non-limiting embodiment, at least a portion or all of the medical device is formed by a 3D printing process.

Another and/or alternative non-limiting object of the present disclosure is the provision of a metal alloy that includes a unique combination of the metals that results in 1) machine tools, machine components, cutting blades, drill bits, grinding bits, shredding/crushing devices and the like having improved ductility as compared to the same metal alloy that is absent rhenium, 2) machine tools, machine components, cutting blades, drill bits, grinding bits, shredding/crushing devices and the like having improved tensile elongation as compared to the same metal alloy that is absent rhenium, 3) a reduction or prevention of micro-crack formation and/or breaking of the metal alloy as compared to the same metal alloy that is absent rhenium, 4) machine tools, machine components, cutting blades, drill bits, grinding bits, shredding/crushing devices and the like having improved ultimate tensile strength and/or yield strength as compared to the same metal alloy that is absent rhenium, an/or 5) machine tools, machine components, cutting blades, drill bits, grinding bits, shredding/crushing devices and the like having improved hardness as compared to the same metal alloy that is absent rhenium.

Another and/or alternative non-limiting object of the present disclosure is the provision of a metal alloy that includes rhenium in an amount of at least 15 awt. % of the metal alloy; and wherein the metal alloy includes one or more alloying metals selected from the group consisting of aluminum, bismuth, chromium, cobalt, copper, hafnium, iridium, iron, magnesium, manganese, molybdenum, nickel, niobium, osmium, platinum, rhodium, ruthenium, silicon, silver, tantalum, technetium, tin, titanium, tungsten, vanadium, yttrium, and zirconium; and wherein the metal alloy has a) an increase of at least 10% in ductility as compared to said metal alloy that is absent rhenium, b) an increase of at least 10% in tensile strength as compared to said metal alloy that is absent rhenium, and/or c) an increase of at least 10% in hardness as compared to said metal alloy that is absent rhenium.

Another and/or alternative non-limiting object of the present disclosure is the provision of a metal alloy that includes rhenium in an amount of at least 15 awt. % of the metal alloy and less than 50 wt. % rhenium; and wherein the metal alloy includes one or more alloying metals selected from the group consisting of aluminum, bismuth, chromium, cobalt, copper, hafnium, iridium, iron, magnesium, manganese, molybdenum, nickel, niobium, osmium, platinum, rhodium, ruthenium, silicon, silver, tantalum, technetium, tin, titanium, tungsten, vanadium, yttrium, and zirconium; and wherein the metal alloy has a) an increase of at least 10% in ductility as compared to said metal alloy that is absent rhenium, b) an increase of at least 10% in tensile strength as compared to said metal alloy that is absent rhenium, and/or c) an increase of at least 10% in hardness as compared to said metal alloy that is absent rhenium.

Other objects, advantages, and novel features of the present invention will become apparent from the following detailed description of the invention when considered in conjunction with the accompanying drawings.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function. The singular forms “a,” “an,” and “the” include plural referents unless the context clearly dictates otherwise.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

In general, it will be apparent to one of ordinary skill in the art that at least some of the embodiments described herein can be implemented in many different embodiments of the disclosure.

The present disclosure is directed to machine tools, machine components, cutting blades, drill bits, grinding bits, shredding/crushing devices and the like that are partially or fully formed of a metal alloy that includes rhenium, and which 1) the machine tools, machine components, cutting blades, drill bits, grinding bits, shredding/crushing devices and the like having improved ductility as compared to the same metal alloy that is absent rhenium, 2) the machine tools, machine components, cutting blades, drill bits, grinding bits, shredding/crushing devices and the like having improved tensile elongation as compared to the same metal alloy that is absent rhenium, 3) a reduction or prevention of micro-crack formation and/or breaking of the metal alloy as compared to the same metal alloy that is absent rhenium, 4) the machine tools, machine components, cutting blades, drill bits, grinding bits, shredding/crushing devices and the like having improved ultimate tensile strength and/or yield strength as compared to the same metal alloy that is absent rhenium, an/or 5) the machine tools, machine components, cutting blades, drill bits, grinding bits, shredding/crushing devices and the like having improved hardness as compared to the same metal alloy that is absent rhenium.

The metal alloy that is used to partially or fully form the machine tools, machine components, cutting blades, drill bits, grinding bits, shredding/crushing devices and the like includes at least 5 awt. % rhenium or at least 5 wt. % rhenium.

When the metal alloy that includes rhenium is used to partially or fully form a cutting blade (e.g., saw blades, rotary blades, knife, rotary cutters, end mill cutters, rounded cutters, ball nosed cutters, radiused cutters, bull nose cutters, etc.), a) the complete cutting blade can be formed of the metal alloy, b) the cutting region of the cutting blade can be formed of the metal alloy, and/or c) the cutting blade can be partially or fully coated with the metal alloy; and the metal alloy coating is at least located on the cutting region of the cutting blade. The rhenium containing metal alloy is used to increase the hardness of the cutting surface of the cutting blade to enhance the life of the cutting blade.

When the metal alloy that includes rhenium is used to partially or fully form a drill bit (e.g., twist drill bit, brad-point drill bit, auger drill bit, self-feed drill bit, installer drill bit, spade bit, forstner drill bit, hole saw, countersink drill bit, plug cutter, step drill bit, tile drill bit, masonry drill bit, etc.), a) the complete drill bit can be formed of the metal alloy, b) the cutting region of the drill bit can be formed of the metal alloy, and/or c) the drill bit can be partially or fully coated with the metal alloy; and the metal alloy coating is at least located on the cutting region of the drill bit. The rhenium containing metal alloy is used to increase the hardness of the cutting surface of the drill bit to enhance the life of the drill bit.

When the metal alloy that includes rhenium is used to partially or fully form a grinding device (e.g., grinding bit, dremel grinding bit, grinding wheel, grinder for angle grinder, grinder for a bench grinder, grinder for a die grinder, grinder for a hand grinder, grinder for a belt grinder. grinder for a pedestal grinder, grinder for a bore grinder, grinder for a precision grinder, grinder for a jig grinder, grinder for a gear grinder, grinder for a surface grinder, grinder for a cylindrical grinder, grinder for a flexible grinder, grinder for a tool and cutter grinder, grinder for a center grinder, grinder for a centerless grinder, grinder for a form grinder, grinder for a plunge-cut grinder, etc.), a) the complete grinding device can be formed of the metal alloy, b) the grinding region of the grinding device can be formed of the metal alloy, and/or c) the grinding device can be partially or fully coated with the metal alloy; and the metal alloy coating is at least located on the grinding region of the grinding device. The rhenium containing metal alloy is used to increase the hardness of the grinding or wearing surface of the grinding device to enhance the life of the grinding device.

When the metal alloy that includes rhenium is used to partially or fully form a shredding/crusher device (e.g., cutters for chipping devices, cutters for hammer mill devices, cutters for metal crusher devices, cutters for paper shredders, cutters for plastic shredders, cutters for metal shredders, cutters for scrap metal shredder, cutters for wood shredders, cutters for tree branch shredders, etc.), a) the complete shredding/crusher can be formed of the metal alloy, b) the cutting or shredding or crushing region of the shredding/crusher can be formed of the metal alloy, and/or c) the shredding/crusher can be partially or fully coated with the metal alloy; and the metal alloy coating is at least located on the cutting or shredding or crushing region of the shredding/crusher. The rhenium containing metal alloy is used to increase the hardness of the cutting and/or wearing surface of the shredding/crusher, and/or to improve the impact and/or wear resistance so as to enhance the life of the shredding/crusher device.

When the metal alloy that includes rhenium is used to partially or fully form a machine tool (e.g., wrenches, plies, screw drives, hammers, crow bar, lathe, presses, turning machines, boring mills, shapers and planers, milling machines, etc.) or a machine component (e.g., axles, gears, clutch components, etc.), a) all or a portion of the complete machine tool or machine component can be formed of the metal alloy, and/or b) the outer surface of machine tool or machine component can be partially or fully coated with the metal alloy. The rhenium containing metal alloy is used to increase the hardness and/or ductility of the machine tool or machine component to enhance the life of the machine tool or machine component.

The description of embodiments and examples has been presented for purposes of illustration and description. It is not intended to be exhaustive or limiting to the forms described. Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A metal alloy that includes rhenium that forms a portion or all of a machine tool, a machine component, a cutting blade, a drill bit, a grinding device, or a shredding/crushing device; said metal alloy includes a) at least 5 awt. % rhenium or b) at least 5 wt. % rhenium; said metal alloy includes one or more alloying metals selected from the group consisting of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium; a combined weight percent of rhenium and alloying metals is at least 90 wt. % of said metal alloy; said metal alloy has a) an increase of at least 10% in ductility as compared to said metal alloy that is absent rhenium, and/or b) an increase of at least 10% in hardness as compared to said metal alloy that is absent rhenium.

2. The metal alloy as defined in claim 1, further including one or more carbides or diborides of one or more metals selected from the group consisting of rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

3. The metal alloy as defined in claim 1, wherein said metal alloy includes rhenium in an amount of at least 15 awt. % of said metal alloy; said metal alloy including one or more alloying metals selected from the group consisting of aluminum, boron, beryllium, bismuth, cadmium, calcium, cerium, chromium, cobalt, copper, gallium, gold, hafnium, iridium, iron, lanthanum, lithium, magnesium, manganese, 0-30 wt. % molybdenum, nickel, niobium, osmium, palladium, platinum, rare earth metals, rhodium, ruthenium, scandium, silver, silicon, tantalum, technetium, tin, titanium, vanadium, yttrium, zinc, and zirconium; said metal alloy has a) an increase of at least 10% in ductility as compared to said metal alloy that is absent rhenium, and/or b) an increase of at least 10% in harness as compared to said metal alloy that is absent rhenium; a combined weight percent of said rhenium and said alloying metals is greater than 95 wt. %.

4. The metal alloy as defined in claim 1, wherein said metal alloy comprises:
I) at least 15 awt. % rhenium and 50-78 wt. % iron, and one or more of a) 9-27 wt. % chromium, b) 0.1-26 wt. % nickel, c) 0.01-7 wt. % molybdenum, d) 0.01-16 wt. % manganese, e) 0.01-4 wt. % silicon, f) 0.01-2 wt. % titanium, g) 0.01-1 wt. % selenium, h) 0.01-1 wt. % niobium, i) 0.01-2 wt. % aluminum, j) 0.01-1 wt. % tantalum, k) 0.01-1 wt. % cobalt, 1) 0.01-5 wt. % copper, m) 0.01-1 wt. % vanadium, and n) 0.01-2 wt. % tungsten; or
II) at least 15 awt. % rhenium and 35-68 wt. % cobalt, and one or more of a) 12-28 wt. % chromium, b) 0.01-38 wt. % nickel, c) 0.1-30 wt. % molybdenum, d) 0.01-2 wt. % manganese, e) 0.01-1 wt. % silicon, f) 0.01-18 wt. % tungsten, g) 0.01-0.5 wt. % lanthanum, h) 0.01-20% wt. % iron, i) 0.01-5 wt. % titanium, j) 0.01-2 wt. % niobium, k) 0.01-2 wt. % aluminum, 1) 0.01-1 wt. % silicon, m) 0.01-0.5 wt. % boron, and n) 0.01-0.5 wt. % silver; or
III) at least 15 awt. % rhenium and 70-91.5 wt. % titanium, and one or more of a) 2-8 wt. % aluminum, b) 0.01-16 wt. % vanadium, c) 0.01-1 wt. % iron, d) 0.01-0.5 wt. % yttrium, e) 0.01-20 wt. % chromium, f) 0-16 wt. % molybdenum, g) 0.01-2 wt. % nickel, h) 0.01-12 wt. % tin, i) 0.01-6 wt. % zirconium, j) 0.01-2 wt. % tantalum, k) 0.01-4 wt. % niobium, 1) 0.01-1 wt. % silicon, and m) 0.01-3 wt. % iron; or
IV) at least 15 awt. % rhenium, 35-84 wt. % tantalum, and one or more of a) 0.1-25 wt. % tungsten, b) 0.1-30 wt. % molybdenum, c) 0.01-45 wt. % niobium, d) 0.01-5 wt. % chromium, f) 0.01-5 wt. % titanium, g) 0.01-5 wt. % zirconium, and h) 0.01-4 wt. % hafnium; or
V) at least 15 awt. % rhenium, 40-85 wt. % niobium, and one or more of a) 0.01-20 wt. % molybdenum, b) 0.01-35 wt. % tantalum, c) 0.01-12 wt. % hafnium, d) 0.01-5 wt. % zirconium, e) 0.01-3 wt. % titanium, f) 0.01-15 wt. % tungsten, and g) 0.01-1 wt. % yttrium; or
VI) at least 15 awt. % rhenium, 30-58 wt. % titanium, and 30-58 wt. % nickel; or
VII) at least 15 awt. % rhenium, and one or more of a) 1-85 awt. % chromium, b) 0.1-10 awt. % titanium, c) 0.1-10 awt. % molybdenum, and d) 0.1-10 awt. % zirconium; or
VIII) at least 15 awt. % rhenium, 40-93 wt. % molybdenum, and one or more of a) 0.1-50 wt. % tantalum, b) 0.1-50 wt. % tungsten, c) 0.01-5 wt. % hafnium, d) 0.01-20% wt. % chromium, e) 0.01-3 wt. % titanium, and f) 0.01-2 wt. % zirconium; or
IX) at least 15 awt. % rhenium, 40-85 wt. % tungsten, and one or more of a) 0.01-30 wt. % molybdenum, b) 0.01-50 wt. % tantalum, d) 0.01-5 wt. % hafnium, d) 0.01-50 wt. % copper, e) 0.01-8 wt. % nickel, f) 0.01-5 wt. % iron, g) 0.01-50 wt. % zirconium, and h) 0.01-20% wt. % chromium.

5. The metal alloy as defined in claim 1, wherein the metal alloy is partially or fully formed by a sinter process.

6. A machine tool, a machine component, a cutting blade, a drill bit, a grinding device, or a shredding/crushing device that is at least partially formed of a metal alloy that includes rhenium; said metal alloy includes a) at least 5 awt. % rhenium or b) at least 5 wt. % rhenium; said metal alloy includes one or more alloying metals selected from the group consisting of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium; a combined weight percent of rhenium and alloying metals is at least 90 wt. % of said metal alloy; said metal alloy has a) an increase of at least 10% in ductility as compared to said metal alloy that is absent rhenium, and/or b) an increase of at least 10% in hardness as compared to said metal alloy that is absent rhenium.

7. The machine tool, a machine component, a cutting blade, a drill bit, a grinding device, or a shredding/crushing device as defined in claim 6, further including one or more carbides or diborides of one or more metals selected from the group consisting of rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

8. The machine tool, a machine component, a cutting blade, a drill bit, a grinding device, or a shredding/crushing device as defined in claim 6, wherein said metal alloy includes rhenium in an amount of at least 15 awt. % of said metal alloy; said metal alloy including one or more alloying metals selected from the group consisting of aluminum, boron, beryllium, bismuth, cadmium, calcium, cerium, chromium, cobalt, copper, gallium, gold, hafnium, iridium, iron, lanthanum, lithium, magnesium, manganese, 0-30 wt. % molybdenum, nickel, niobium, osmium, palladium, platinum, rare earth metals, rhodium, ruthenium, scandium, silver, silicon, tantalum, technetium, tin, titanium, vanadium, yttrium, zinc, and zirconium; said metal alloy has a) an increase of at least 10% in ductility as compared to said metal alloy that is absent rhenium, and/or b) an increase of at least 10% in harness as compared to said metal alloy that is absent rhenium; a combined weight percent of said rhenium and said alloying metals is greater than 95 wt. %.

9. The machine tool, a machine component, a cutting blade, a drill bit, a grinding device, or a shredding/crushing device as defined in claim 6, wherein said metal alloy comprises:
I) at least 15 awt. % rhenium and 50-78 wt. % iron, and one or more of a) 9-27 wt. % chromium, b) 0.1-26 wt. % nickel, c) 0.01-7 wt. % molybdenum, d) 0.01-16 wt. % manganese, e) 0.01-4 wt. % silicon, f) 0.01-2 wt. % titanium, g) 0.01-1 wt. % selenium, h) 0.01-1 wt. % niobium, i) 0.01-2 wt. % aluminum, j) 0.01-1 wt. % tantalum, k) 0.01-1 wt. % cobalt, 1) 0.01-5 wt. % copper, m) 0.01-1 wt. % vanadium, and n) 0.01-2 wt. % tungsten; or
II) at least 15 awt. % rhenium and 35-68 wt. % cobalt, and one or more of a) 12-28 wt. % chromium, b) 0.01-38 wt. % nickel, c) 0.1-30 wt. % molybdenum, d) 0.01-2 wt. % manganese, e) 0.01-1 wt. % silicon, f) 0.01-18 wt. % tungsten, g) 0.01-0.5 wt. % lanthanum, h) 0.01-20% wt. % iron, i) 0.01-5 wt. % titanium, j) 0.01-2 wt. % niobium, k) 0.01-2 wt. % aluminum, 1) 0.01-1 wt. % silicon, m) 0.01-0.5 wt. % boron, and n) 0.01-0.5 wt. % silver; or
III) at least 15 awt. % rhenium and 70-91.5 wt. % titanium, and one or more of a) 2-8 wt. % aluminum, b) 0.01-16 wt. % vanadium, c) 0.01-1 wt. % iron, d) 0.01-0.5 wt. % yttrium, e) 0.01-20 wt. % chromium, f) 0-16 wt. % molybdenum, g) 0.01-2 wt. % nickel, h) 0.01-12 wt. % tin, i) 0.01-6 wt. % zirconium, j) 0.01-2 wt. % tantalum, k) 0.01-4 wt. % niobium, 1) 0.01-1 wt. % silicon, and m) 0.01-3 wt. % iron; or
IV) at least 15 awt. % rhenium, 35-84 wt. % tantalum, and one or more of a) 0.1-25 wt. % tungsten, b) 0.1-30 wt. % molybdenum, c) 0.01-45 wt. % niobium, d) 0.01-5 wt. % chromium, f) 0.01-5 wt. % titanium, g) 0.01-5 wt. % zirconium, and h) 0.01-4 wt. % hafnium; or
V) at least 15 awt. % rhenium, 40-85 wt. % niobium, and one or more of a) 0.01-20 wt. % molybdenum, b) 0.01-35 wt. % tantalum, c) 0.01-12 wt. % hafnium, d) 0.01-5 wt. % zirconium, e) 0.01-3 wt. % titanium, f) 0.01-15 wt. % tungsten, and g) 0.01-1 wt. % yttrium; or
VI) at least 15 awt. % rhenium, 30-58 wt. % titanium, and 30-58 wt. % nickel; or
VII) at least 15 awt. % rhenium, and one or more of a) 1-85 awt. % chromium, b) 0.1-10 awt. % titanium, c) 0.1-10 awt. % molybdenum, and d) 0.1-10 awt. % zirconium; or
VIII) at least 15 awt. % rhenium, 40-93 wt. % molybdenum, and one or more of a) 0.1-50 wt. % tantalum, b) 0.1-50 wt. % tungsten, c) 0.01-5 wt. % hafnium, d) 0.01-20% wt. % chromium, e) 0.01-3 wt. % titanium, and f) 0.01-2 wt. % zirconium; or
IX) at least 15 awt. % rhenium, 40-85 wt. % tungsten, and one or more of a) 0.01-30 wt. % molybdenum, b) 0.01-50 wt. % tantalum, d) 0.01-5 wt. % hafnium, d) 0.01-50 wt. % copper, e) 0.01-8 wt. % nickel, f) 0.01-5 wt. % iron, g) 0.01-50 wt. % zirconium, and h) 0.01-20% wt. % chromium.

10. The machine tool, a machine component, a cutting blade, a drill bit, a grinding device, or a shredding/crushing device as defined in claim 6, wherein the metal alloy is partially or fully formed by a sinter process.

11. The machine tool, a machine component, a cutting blade, a drill bit, a grinding device, or a shredding/crushing device as defined in claim 6, wherein said cutting blade includes a cutting edge; said cutting edge is formed of and/or is coated with said metal alloy.

12. The machine tool, a machine component, a cutting blade, a drill bit, a grinding device, or a shredding/crushing device as defined in claim 6, wherein said drill bit includes a cutting edge; said cutting edge is formed of and/or is coated with said metal alloy.

13. The machine tool, a machine component, a cutting blade, a drill bit, a grinding device, or a shredding/crushing device as defined in claim 6, wherein said grinding device includes a grinding surface that is configured to grind other material upon contact with said other material; said grinding surface is formed of and/or is coated with said metal alloy.

14. The machine tool, a machine component, a cutting blade, a drill bit, a grinding device, or a shredding/crushing device as defined in claim 6, wherein said shredding/crushing device includes a shredding surface that is configured to shred and/or crush other material upon contact with said other material; said shredding surface is formed of and/or is coated with said metal alloy.

15. The machine tool, a machine component, a cutting blade, a drill bit, a grinding device, or a shredding/crushing device as defined in claim 6, wherein a portion or all of an outer surface of said metal alloy is coated with an enhancement coating; said enhancement coating includes chromium nitride (CrN), diamond-like carbon (DLC), titanium nitride (TiN), titanium nitride oxide (TiNOx), zirconium nitride (ZrN), zirconium oxide (ZrO₂), zirconium-nitrogen-carbon (ZrNC), zirconium OxyCarbide (ZrOC), zirconium oxynitride (ZnNxOy) [e.g., cubic ZrN:O, cubic ZrO₂:N, tetragonal ZrO₂:N, and monoclinic ZrO₂:N phase coatings], and combinations of such coatings.

16. A method for forming a metal alloy that is used to at least partially form or coat a machine tool, a machine component, a cutting blade, a drill bit, a grinding device, or a shredding/crushing device comprising:
a. providing metal powder; said metal powder having i) an average particle size of 2-62 microns, ii) an average density of greater than 5 g/cm3, and/or iii) Hall flow (s/50 g) of less than 30 seconds; said metal powder at least partially having a metal composition of a) at least 5 awt. % rhenium or b) at least 5 wt. % rhenium; said metal alloy includes one or more alloying metals selected from the group consisting of aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium; a combined weight percent of rhenium and alloying metals is at least 90 wt. % of said metal alloy; and
b. A) using 3D printing technology or direct metal printing technology to at least partially form and/or at least partially coat said machine tool, said machine component, said cutting blade, said drill bit, said grinding device, or said shredding/crushing device with said metal alloy, and/or
B) using a sintering process to at least partially form and/or at least partially coat said machine tool, said machine component, said cutting blade, said drill bit, said grinding device, or said shredding/crushing device with said metal alloy.

17. The method as defined in claim 16, wherein said metal powder includes one or more carbides or diborides of one or more metals selected from the group consisting of rhenium, aluminum, boron, beryllium, bismuth, cadmium, calcium, carbon, cerium, chromium, cobalt, copper, gallium, gold, hafnium, iridium, iron, lanthanum, lithium, magnesium, manganese, molybdenum, nickel, niobium, osmium, palladium, platinum, rare earth metals, rhodium, ruthenium, scandium, silver, silicon, tantalum, technetium, tin, titanium, tungsten, vanadium, yttrium, zinc, and zirconium.

18. The method as defined in claim 16, wherein said metal alloy includes rhenium in an amount of at least 15 awt. % of said metal alloy; said metal alloy including one or more alloying metals selected from the group consisting of aluminum, boron, beryllium, bismuth, cadmium, calcium, cerium, chromium, cobalt, copper, gallium, gold, hafnium, iridium, iron, lanthanum, lithium, magnesium, manganese, 0-30 wt. % molybdenum, nickel, niobium, osmium, palladium, platinum, rare earth metals, rhodium, ruthenium, scandium, silver, silicon, tantalum, technetium, tin, titanium, vanadium, yttrium, zinc, and zirconium; said metal alloy has a) an increase of at least 10% in ductility as compared to said metal alloy that is absent rhenium, and/or b) an increase of at least 10% in harness as compared to said metal alloy that is absent rhenium; a combined weight percent of said rhenium and said alloying metals is greater than 95 wt. %.

19. The method as defined in claim 16, wherein said metal powder comprises:
I) at least 15 awt. % rhenium and 50-78 wt. % iron, and one or more of a) 9-27 wt. % chromium, b) 0.1-26 wt. % nickel, c) 0.01-7 wt. % molybdenum, d) 0.01-16 wt. % manganese, e) 0.01-4 wt. % silicon, f) 0.01-2 wt. % titanium, g) 0.01-1 wt. % selenium, h) 0.01-1 wt. % niobium, i) 0.01-2 wt. % aluminum, j) 0.01-1 wt. % tantalum, k) 0.01-1 wt. % cobalt, 1) 0.01-5 wt. % copper, m) 0.01-1 wt. % vanadium, and n) 0.01-2 wt. % tungsten; or
II) at least 15 awt. % rhenium and 35-68 wt. % cobalt, and one or more of a) 12-28 wt. % chromium, b) 0.01-38 wt. % nickel, c) 0.1-30 wt. % molybdenum, d) 0.01-2 wt. % manganese, e) 0.01-1 wt. % silicon, f) 0.01-18 wt. % tungsten, g) 0.01-0.5 wt. % lanthanum, h) 0.01-20% wt. % iron, i) 0.01-5 wt. % titanium, j) 0.01-2 wt. % niobium, k) 0.01-2 wt. % aluminum, 1) 0.01-1 wt. % silicon, m) 0.01-0.5 wt. % boron, and n) 0.01-0.5 wt. % silver; or
III) at least 15 awt. % rhenium and 70-91.5 wt. % titanium, and one or more of a) 2-8 wt. % aluminum, b) 0.01-16 wt. % vanadium, c) 0.01-1 wt. % iron, d) 0.01-0.5 wt. % yttrium, e) 0.01-20 wt. % chromium, f) 0-16 wt. % molybdenum, g) 0.01-2 wt. % nickel, h) 0.01-12 wt. % tin, i) 0.01-6 wt. % zirconium, j) 0.01-2 wt. % tantalum, k) 0.01-4 wt. % niobium, 1) 0.01-1 wt. % silicon, and m) 0.01-3 wt. % iron; or
IV) at least 15 awt. % rhenium, 35-84 wt. % tantalum, and one or more of a) 0.1-25 wt. % tungsten, b) 0.1-30 wt. % molybdenum, c) 0.01-45 wt. % niobium, d) 0.01-5 wt. % chromium, f) 0.01-5 wt. % titanium, g) 0.01-5 wt. % zirconium, and h) 0.01-4 wt. % hafnium; or
V) at least 15 awt. % rhenium, 40-85 wt. % niobium, and one or more of a) 0.01-20 wt. % molybdenum, b) 0.01-35 wt. % tantalum, c) 0.01-12 wt. % hafnium, d) 0.01-5 wt. % zirconium, e) 0.01-3 wt. % titanium, f) 0.01-15 wt. % tungsten, and g) 0.01-1 wt. % yttrium; or
VI) at least 15 awt. % rhenium, 30-58 wt. % titanium, and 30-58 wt. % nickel; or
VII) at least 15 awt. % rhenium, and one or more of a) 1-85 awt. % chromium, b) 0.1-10 awt. % titanium, c) 0.1-10 awt. % molybdenum, and d) 0.1-10 awt. % zirconium; or
VIII) at least 15 awt. % rhenium, 40-93 wt. % molybdenum, and one or more of a) 0.1-50 wt. % tantalum, b) 0.1-50 wt. % tungsten, c) 0.01-5 wt. % hafnium, d) 0.01-20% wt. % chromium, e) 0.01-3 wt. % titanium, and f) 0.01-2 wt. % zirconium; or
IX) at least 15 awt. % rhenium, 40-85 wt. % tungsten, and one or more of a) 0.01-30 wt. % molybdenum, b) 0.01-50 wt. % tantalum, d) 0.01-5 wt. % hafnium, d) 0.01-50 wt. % copper, e) 0.01-8 wt. % nickel, f) 0.01-5 wt. % iron, g) 0.01-50 wt. % zirconium, and h) 0.01-20% wt. % chromium.

20. The method as defined in claim 16, and further including the step of coating at least a portion of an outer surface of said metal alloy with an enhancement coating; said enhancement coating includes chromium nitride (CrN), diamond-like carbon (DLC), titanium nitride (TiN), titanium nitride oxide (TiNOx), zirconium nitride (ZrN), zirconium oxide (ZrO₂), zirconium-nitrogen-carbon (ZrNC), zirconium OxyCarbide (ZrOC), zirconium oxynitride (ZnNxOy) [e.g., cubic ZrN:O, cubic ZrO₂:N, tetragonal ZrO₂:N, and monoclinic ZrO₂:N phase coatings], and combinations of such coatings.
